(19) United States
(12) Patent Application Publication
(10) Pub. No.: US 2017/0078618 A1
(43) Pub. Date: Mar. 16, 2017

(54) DISPLAY CONTROL DEVICE, DISPLAY CONTROL SYSTEM, AND DISPLAY CONTROL METHOD

(71) Applicant: Kabushiki Kaisha Toshiba, Tokyo (JP)

(72) Inventors: Tomoyuki SHIBATA, Kawasaki Kanagawa (JP); Yuto YAMAJI, Kawasaki Kanagawa (JP); Tomoki WATANABE, Inagi Tokyo (JP); Quoc Viet PHAM, Yokohama Kanagawa (JP); Tomokazu KAWAHARA, Yokohama Kanagawa (JP); Masayuki MARUYAMA, Koto Tokyo (JP); Osamu YAMAGUCHI, Yokohama Kanagawa (JP)

(21) Appl. No.: 15/257,720

(22) Filed: Sep. 6, 2016

(30) Foreign Application Priority Data
Sep. 11, 2015 (JP) 2015-180163
Mar. 22, 2016 (JP) 2016-057241

(51) Int. Cl. H04N 7/18; G06T 7/00; G06F 3/14; G06K 9/00

(52) U.S. Cl. CPC H04N 7/181; G06K 9/00778; G06T 7/004; G06F 3/1407; G06T 2207/10016; G06T 2207/30232; G06T 2207/30196

(57) ABSTRACT

According to an embodiment, a display control device includes hardware processing circuitry. The hardware processing circuitry programmed to acquire event information indicating an event and event position information indicating a location of the event, the event detected from an image captured by an imager; calculate a priority for displaying the event information based on at least one of the event position information or the event information; determine a display format of the event information based at least in part on the priority; and cause a display to display the event information in accordance with the display format determined.

### CROSS-REFERENCE TO RELATED APPLICATIONS

This application is based upon and claims the benefit of priority from Japanese Patent Application No. 2015-180163, filed on Sep. 11, 2015; and Japanese Patent Application No. 2016-057241, filed on Mar. 22, 2016, the entire contents of all of which are incorporated herein by reference.

### FIELD

Embodiments described herein relate generally to a display control device, a display control system, and a display control method.

### BACKGROUND

Information providing apparatuses have been known that use monitoring devices that perform surrounding monitoring with monitoring cameras, for example, and distribute monitored information (content) to surrounding display devices. An object of such information providing apparatuses is to control a flow line of people without changing a display among display devices or by controlling different displays among the display devices such that a relevant moving image is displayed among the display devices, for example.

The thus structured information providing apparatus cannot control display content on the basis of an event detected by a monitoring camera. The event is a preliminarily assumed person's action, phenomenon, or situation, for example. An information providing system including a plurality of display devices has a problem in that, when event detection by the monitoring device, which serves as a trigger to control display content, occurs simultaneously and in a multiple manner, it is impossible to control which display device displays information about the event. As described above, the conventional information providing apparatus (display control device) has a problem in that it is impossible to monitor surrounding information by the monitoring device to automatically control display content in the display device in accordance with a detected event.

### BRIEF DESCRIPTION OF THE DRAWINGS

FIG. 1 is a schematic diagram illustrating an exemplary structure of a display control system;

FIG. 2 is a schematic diagram illustrating an exemplary hardware structure of an image processing unit;

FIG. 3 is a schematic diagram illustrating an exemplary hardware structure of an arithmetic processing unit;

FIG. 4 is a schematic diagram illustrating an exemplary functional block structure of a display control system in a first embodiment;

FIG. 5 is a schematic diagram explaining operation that obtains a three dimensional position from an image;

FIG. 6 is a schematic diagram illustrating an exemplary display of event information;

FIG. 7 is a flowchart illustrating exemplary display control operation of the display control system in the first embodiment;

FIG. 8 is a schematic diagram illustrating an exemplary structure of a display control system in a second embodiment;

FIG. 9 is a schematic diagram explaining an example of the display control devices that display the event information;

FIG. 10 is a schematic diagram illustrating an exemplary functional block structure of a display control system in a third embodiment;

FIG. 11 is a schematic diagram illustrating an exemplary functional block structure of a display control system in a fourth embodiment;

FIG. 12 is a schematic diagram illustrating an exemplary functional block structure of a display control system in a fifth embodiment; and

FIG. 13 is a schematic diagram illustrating an exemplary functional block structure of a display control system in a sixth embodiment.

### DETAILED DESCRIPTION

According to an embodiment, a display control device includes hardware processing circuitry. The hardware processing circuitry programmed to acquire event information indicating an event and event position information indicating a location of the event, the event detected from an image captured by an imager; calculate a priority for displaying the event information based on at least one of the event position information or the event information; determine a display format of the event information based at least in part on the priority; and cause a display to display the event information in accordance with the display format determined.

The following describes embodiments of a display control device, a display control system, and a display control method in detail with reference to the accompanying drawings. The drawings are schematically illustrated. The specific structures, thus, should be determined by considering the following description.

### First Embodiment

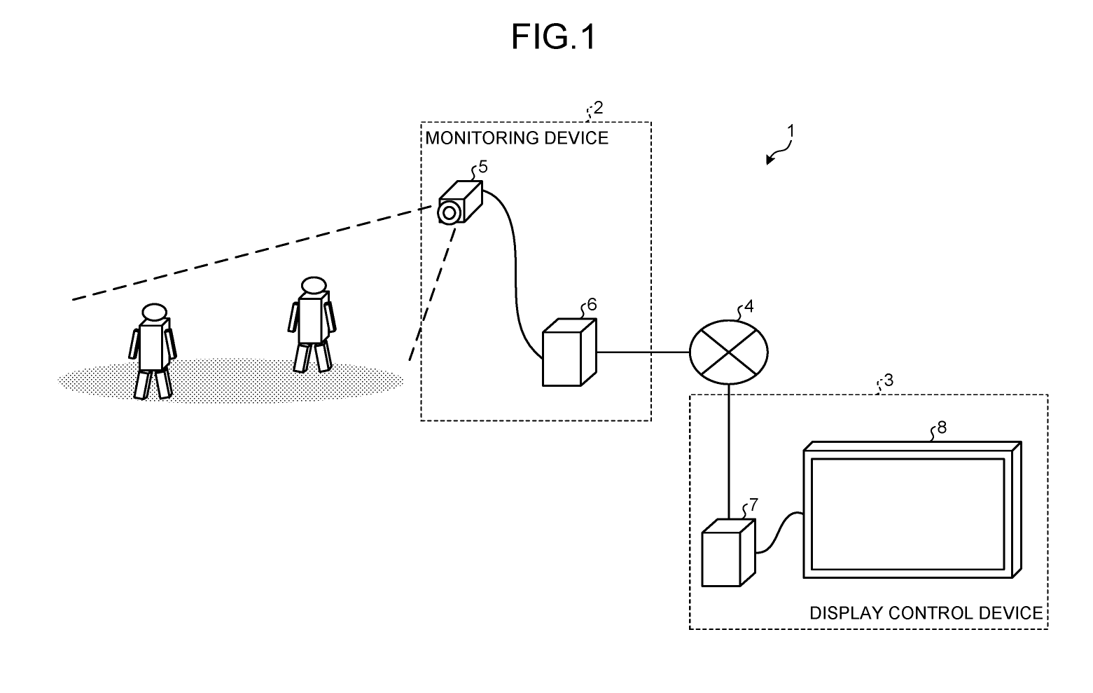

FIG. 1 is a schematic diagram illustrating an exemplary structure of a display control system. The structure of a display control system 1 is described with reference to FIG. 1.

As illustrated in FIG. 1, the display control system 1 according to a first embodiment includes a monitoring device 2 (imaging device) and a display control device 3. The monitoring device 2 and the display control device 3 are communicably coupled via a network 4. The display control system 1 is used for an advertising system that applies to a flow of people in a commercial facility or a security system that makes notification of a specific person detected by the monitoring device 2, for example.

The monitoring device 2 images a surrounding environment and detects an event from a captured image (frame). The event is a preliminarily assumed person's action, phenomenon, or situation, for example. The monitoring device 2 includes an imaging unit 5 and an image processing unit 6.

The imaging unit 5 is a camera that captures a moving image or a still image of the surrounding environment. The imaging unit 5 transmits the captured moving image or still image to the image processing unit 6.

The image processing unit 6 is a device that detects an event from the frame of the moving image or still image received from the imaging unit 5 and performs image processing that estimates a position where the event occurs. The image processing unit 6 transmits, to the display control device 3 via the network 4, information about the event (hereinafter described as event information) and information about the position where the event occurs (hereinafter described as event position information), which are the result of the image processing. The event means a predetermined occurrence. For example, detection of a registered person or vehicle may be defined as the event. For another example, a case where a difference captured between frames is equal to or larger than a threshold may be defined as the event. A specific action may be identified by tracking target person's actions in several frames. For example, a movement such as standing up or waving a hand may be defined as the event. Examples of the event information include a name of the generated event, a message about the event, information indicating a person or an object detected as the event, a frame (image) from which an event is detected, and information indicating a time when the event occurs.

The display control device 3 is a device that performs display control of the event information on the basis of a content of the event indicated by the event information received from the monitoring device 2 and a distance between the display control device 3 and the position where the event occurs. The display control device 3 includes an arithmetic processing unit 7 and a display 8.

The arithmetic processing unit 7 is a device that calculates a priority in relation to the display of the event information on the basis of a content of the event indicated by the event information received from the monitoring device 2 and a distance between the display control device 3 and the position where the event occurs, and determines the display content (display manner) of the event information, for example, on the basis of the priority.

The display 8 is a display device that displays the event information on the basis of the result of determination on the display content of the event information, for example, by the arithmetic processing unit 7. The display device is a liquid crystal display, a plasma display, or an organic electro-luminescence (EL) display, for example.

The network 4 is a network that enables data communication between the monitoring device 2 and the display control device 3. The communication may be performed in a wired or a wireless manner. The network 4 is a local area network (LAN) compliant with a communication protocol such as a transmission control protocol (TCP)/internet protocol (IP), for example. When the network 4 is a wireless network, the wireless network may be a network that is, for example, compliant with a communication standard such as wireless fidelity (Wi-Fi, which is a registered trademark), for example.

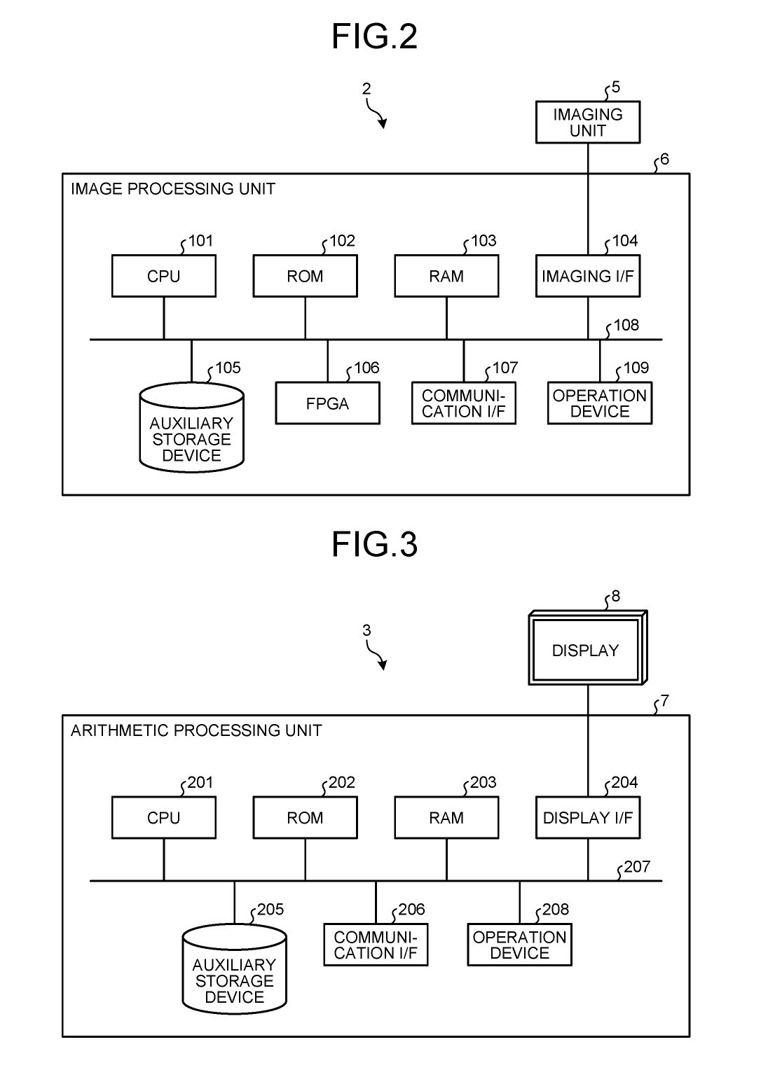

FIG. 2 is a schematic diagram illustrating an exemplary hardware structure of the image processing unit. The following describes the hardware structure of the image processing unit 6 of the monitoring device 2 with reference to FIG. 2.

As illustrated in FIG. 2, the image processing unit 6 includes a central processing unit (CPU) 101, a read only memory (ROM) 102, a random access memory (RAM) 103, an imaging interface (I/F) 104, an auxiliary storage device 105, a field programmable gate array (FPGA) 106, a communication I/F 107, and an operation device 109. The image processing unit 6 is achieved by a general purpose computer such as a typical personal computer (PC), a work station, or a server.

The CPU 101 is a computing device that controls the whole operation of the image processing unit 6. The ROM 102 is a non-volatile storage device that stores therein programs executed by the CPU 101 for controlling respective functions. The RAM 103 is a volatile storage device that functions as a working memory of the CPU 101, for example.

The imaging I/F 104 is an interface to perform data communication with the imaging unit 5, which is a camera. The imaging I/F 104 may be an interface compliant with a transmission standard of a universal serial bus (USB) or a protocol of the TCP/IP.

The auxiliary storage device 105 is a non-volatile storage device that stores therein various programs executed by the CPU 101 and data of moving images or still images captured by the imaging unit 5. The auxiliary storage device 105 is a storage device capable of electrically, magnetically, or optically storing data such as a hard disk drive (HDD), a solid state drive (SSD), a flash memory, or an optical disc.

The FPGA 106 is an integrated circuit that performs the image processing such as event detection processing, which is described later, on the frame of a moving image or still image (hereinafter simply described as the frame in some cases) received from the imaging unit 5. The FPGA 106 is not limited to the FPGA, but it may be an integrated circuit such as an application specific integrated circuit (ASIC).

The communication I/F 107 is a network interface to connect to the network 4 so as to perform data communication with the arithmetic processing unit 7. The communication I/F 107 is achieved by a network interface card (NIC) compliant with Ethernet (registered trademark), for example.

The operation device 109 allows a user to perform operation input so as to cause the CPU 101 to execute certain processing. Examples of the operation input include input of characters and numbers, input of operation for selecting various instructions, and input of operation for moving a cursor. The operation device 109 is an input device such as a mouse, a keyboard, numeric keys, a touch pad, or a touch panel, for example. The operation device 109 is not necessarily included in the image processing unit 6.

The CPU 101, the ROM 102, the RAM 103, the imaging I/F 104, the auxiliary storage device 105, the FPGA 106, the communication I/F 107, and the operation device 109 are communicably coupled to one another with a bus 108 such as an address bus or a data bus.

The image processing unit 6 is achieved by a general purpose computer such as a PC, but not limited thereto. The image processing unit 6 may be achieved by a built-in system (dedicated device) that achieves specific functions of the image processing unit 6.

FIG. 3 is a schematic diagram illustrating an exemplary hardware structure of the arithmetic processing unit. The following describes the hardware structure of the arithmetic processing unit 7 of the display control device 3 with reference to FIG. 3.

As illustrated in FIG. 3, the arithmetic processing unit 7 includes a CPU 201, a ROM 202, a RAM 203, a display I/F 204, an auxiliary storage device 205, a communication I/F 206, and an operation device 208. The arithmetic processing unit 7 is achieved by a general purpose computer such as a typical PC, a work station, or a server.

The CPU 201 is a computing device that controls the whole operation of the arithmetic processing unit 7. The ROM 202 is a non-volatile storage device that stores therein programs executed by the CPU 201 for controlling respective functions. The RAM 203 is a volatile storage device that functions as a working memory of the CPU 201, for example.

The display I/F 204 is an interface to transmit display data to the display 8 serving as the display device, the interface being compliant with a video graphic array (VGA), a digital visual interface (DVI), or a high-definition multimedia interface (HDMI, which is a registered trademark), for example.

The auxiliary storage device 205 is a non-volatile storage device that stores therein various programs executed by the CPU 201 and position information about the display control device 3 (hereinafter described as display position information). The auxiliary storage device 205 is a storage device capable of electrically, magnetically, or optically storing data such as an HDD, an SSD, a flash memory, or an optical disc.

The communication I/F 206 is a network interface to connect to the network 4 so as to perform data communication with the image processing unit 6. The communication I/F 206 is achieved by a NIC compliant with Ethernet (registered trademark), for example.

The operation device 208 allows a user to perform operation input so as to cause the CPU 201 to execute a certain processing. The operation device 208 is an input device such as a mouse, a keyboard, numeric keys, a touch pad, or a touch panel, for example. The operation device 208 is not necessarily included in the arithmetic processing unit 7.

The CPU 201, the ROM 202, the RAM 203, the display I/F 204, the auxiliary storage device 205, the communication I/F 206, and the operation device 208 are communicably coupled to one another with a bus 207 such as an address bus or a data bus.

The arithmetic processing unit 7 is achieved by a general purpose computer such as a PC, but not limited thereto. The arithmetic processing unit 7 may be achieved by a built-in system (dedicated device) that achieves specific functions of the arithmetic processing unit 7, or a mobile terminal that integrally includes the arithmetic processing unit 7 and the display 8.

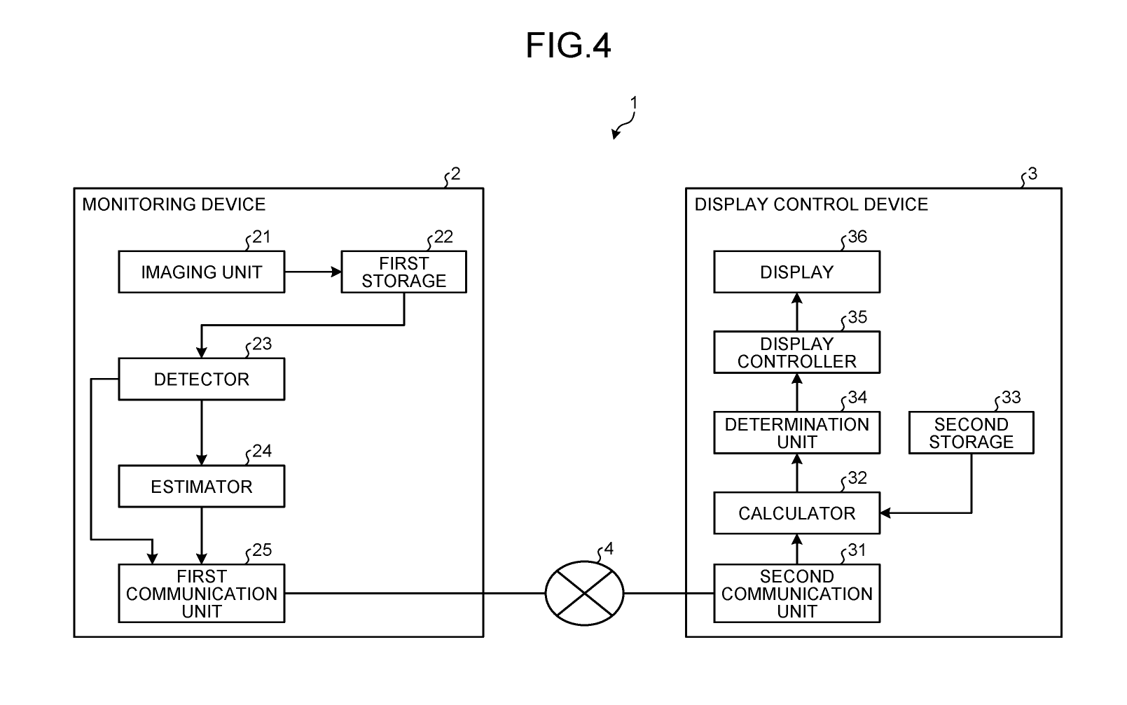

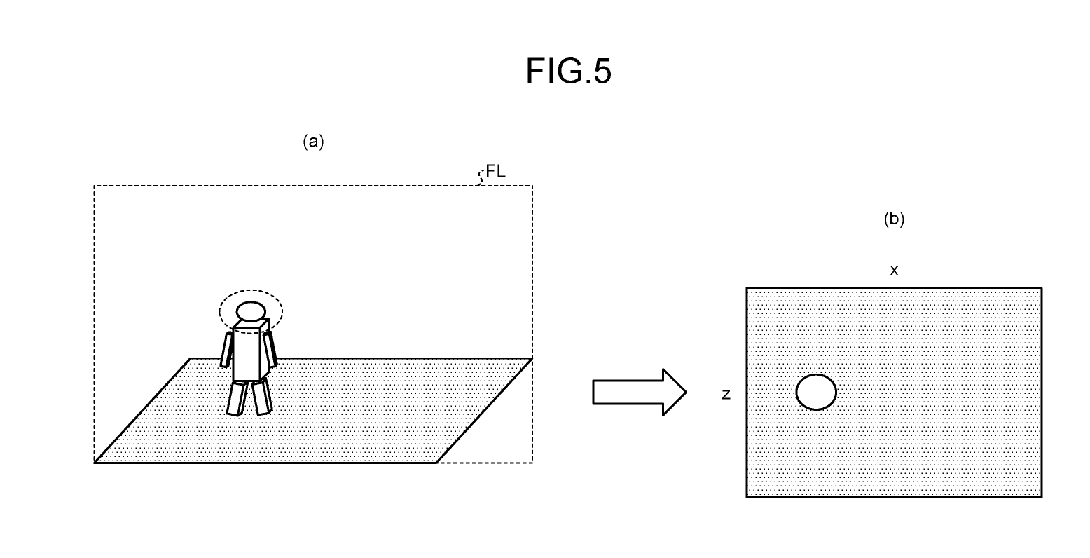

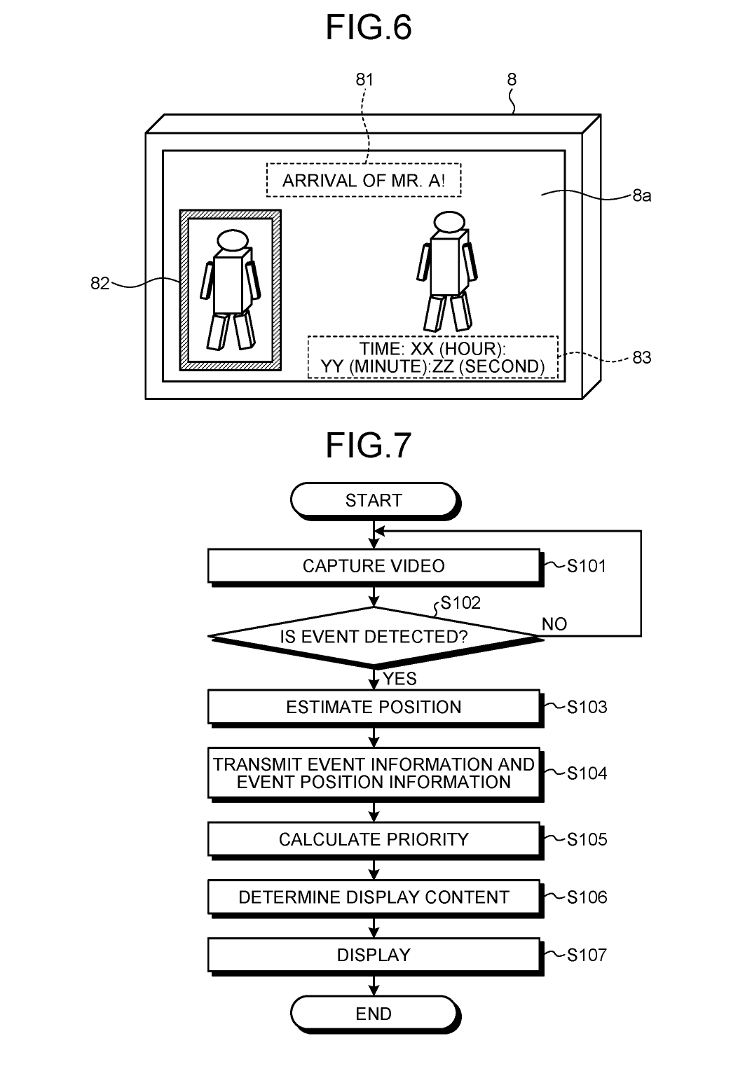

FIG. 4 is a schematic diagram illustrating an exemplary functional block structure of the display control system in the first embodiment. FIG. 5 is a schematic diagram explaining operation that obtains a three dimensional position from an image. FIG. 6 is a schematic diagram illustrating an exemplary display of the event information. The following describes the functional block structure and the operation of the display control system 1 with reference to FIGS. 4 to 6.

As illustrated in FIG. 4, the monitoring device 2 of the display control system 1 includes an imaging unit 21, a first storage 22, a detector 23, an estimator 24, and a first communication unit 25 (transmitter).

The imaging unit 21 is a functional unit that captures a moving image or a still image of the surrounding environment. The imaging unit 21 causes the first storage 22 to store therein data of the captured moving image or still image. The imaging unit 21 is achieved by the imaging unit 5 illustrated in FIG. 2.

The first storage 22 is a functional unit that stores therein the data of moving image or still image captured by the imaging unit 21 and the event information associated with the event detected by the detector 23, which is described later, for example. The first storage 22 is achieved by at least one of the RAM 103 or the auxiliary storage device 105 illustrated in FIG. 2.

The detector 23 is a functional unit that detects the occurrence of the event such as a preliminarily assumed person's action, phenomenon, or situation from the frame, which is the moving image or still image stored in the first storage 22. The following describes the examples of the event detected by the detector 23.

The detector 23 may detect the event of a preliminarily registered specific person being present, for example. In this case, the detector 23 detects the face of a person from each frame of the moving image stored in the first storage 22, calculates a feature amount from the face region, compares the calculated feature amount with the feature amount of the preliminarily registered specific person, and determines that the detected person is the registered specific person when a difference between the calculated feature amount and the feature of the registered person is equal to or smaller than a certain threshold. The detector 23 may not necessarily perform processing on all of the frames of the moving image but may perform thinning processing such as the implementation of the processing once per several frames, or may perform tracking processing on the next frame onwards after the detection processing of the person's face is performed on a certain frame.

The detector 23 may detect the event of a person who has a specific attribute being present, for example. Examples of the specific attribute include an attribute that can be assumed from an outer appearance such as age or race, an attribute of the person wearing eyeglasses, a mask, or a beard, and an attribute relating to the person's facial expression such as a smile or embarrassment. The detector 23 detects the face of a person from each frame of the moving image stored in the first storage 22, calculates a feature amount from the face region, and determines whether the person has a specific attribute by collating the calculated feature amount with a dictionary that determines likelihood of a preliminarily registered attribute. The detector 23 may determine that the event is detected when at least one or more persons who have at least one or more set characteristic attributes are present.

The detector 23 may detect the event of a pedestrian entering a certain entrance-forbidden region, for example. As for a method for detecting a pedestrian, a method described in Japanese Patent Application Laid-open No. 2005-33518 is known, for example. The detector 23 may detect an attribute (a type of action, for example) of the pedestrian on the basis of features of the action and appearance of the pedestrian, and include the information about the attribute in the event information. As for a method for detecting an attribute of a pedestrian, a method described in Japanese Patent Application Laid-open No. 2008-276455 is known, for example. When detecting the attribute of the pedestrian, the detector 23 may determine that the event is detected when at least one or more persons who have at least one or more set specific attributes are present.

The detector 23 may perform human detection in a region kept for a certain time period on the basis of a difference between a frame of the moving image or still image stored in the first storage 22 and preliminarily set background information, and determine whether the detected object is human or other than human. In this case, when a human is detected as a result of the human detection, the detector 23 detects the event of the human staying for a certain time period. When the detected object is other than human, the detector 23 detects the event of the object being mislaid. Further more, when determining that the object is other than human, the detector 23 may determine what is the object kept for a certain time period by object recognition processing, and include the recognition result in the event information.

When detecting the event, the detector 23 acquires the event information associated with the event from the first storage 22, and sends the acquired event information to the first communication unit 25. The detector 23 is achieved by the FPGA 106 illustrated in FIG. 2. The event information sent to the first communication unit 25 from the detector 23 is not limited to the information stored in the first storage 22. The detector 23 may send information produced on the basis of the detected event (e.g., the frame (image) from which the event is detected, or information about a time when the event occurs) to the first communication unit 25 as the event information.

The estimator 24 is a functional unit that estimates a location of the event on the basis of the frame from which the event is detected when the event is detected by the detector 23. The location of the event is indicated by a position of the person or the thing, for example, which is the object detected as the event, in a world coordinate system. Specifically, the estimator 24 transforms the floor surface included in a frame FL (image) from which the event is detected, which is illustrated at (a) in FIG. 5, to x-z plane (refer to (b) in FIG. 5) by a nomography matrix that projects the floor surface on the x-z plane. Thereafter, the estimator 24 adds a bias term to the translation result, thereby estimating the position of the person or the thing, for example, which is the object detected as the event, in the world coordinate system. For example, the head of the person (indicated with the enclosure dot line) at (a) in FIG. 5 is detected, and is transformed to the circle at (b) in FIG. 5. The human detection may be performed on a face or whole body basis. The estimator 24 sends the information (event position information) about the estimated location of the event to the first communication unit 25. The estimator 24 is achieved by the FPGA 106 illustrated in FIG. 2. The imaging unit 21 may be a three-dimensional camera and directly obtain the location of the event.

The first communication unit 25 is a functional unit that transmits the event information received from the detector 23 and the event position information received from the estimator 24 to the display control device 3 via the network 4. The first communication unit 25 is achieved by the communication I/F 107 illustrated in FIG. 2.

The imaging unit 21, the first storage 22, the detector 23, the estimator 24, and the first communication unit 25, which are included in the monitoring device 2 illustrated in FIG. 4, conceptually represent the functions of the monitoring device 2. The functional structure of the monitoring device 2 is not limited to that illustrated in FIG. 4. For example, the functional units illustrated in FIG. 4 as independent functional units of the monitoring device 2 may be structured as a single functional unit. The function of one of the functional units included in the monitoring device 2 illustrated in FIG. 4 may be divided into a plurality of functions and structured as a plurality of functional units.

A part or the whole of the detector 23 and the estimator 24 may be achieved by causing the CPU 101 to execute a program stored in the ROM 102 or the auxiliary storage device 105 illustrated in FIG. 2 instead of being achieved by the FPGA 106.

As illustrated in FIG. 4, the display control device 3 of the display control system 1 includes a second communication unit 31 (receiving unit), a calculator 32, a second storage 33 (storage), a determination unit 34, a display controller 35, and a display 36.

The second communication unit 31 is a functional unit that receives the event information and the event position information from the monitoring device 2 via the network 4. The second communication unit 31 sends the received event information and event position information to the calculator 32. The second communication unit 31 is achieved by the communication I/F 206 illustrated in FIG. 3.

The calculator 32 is a functional unit that calculates the priority for displaying the event information in the display 36 on the basis of at least one of the event information or the event position information that are received from the second communication unit 31. Specifically, the calculator 32 obtains a distance between the location of the event and a position where the display 8 is installed on the basis of the location of the event, which is indicated by the event position information received from the second communication unit 31, and the position indicated by information (hereinafter described as the display position information) about the position where the display 8 is installed in the world coordinate system. The display position information is stored in the second storage 33, as described later. The display position information about the display 8 is to be stored in the second storage 33, but not limited thereto. When the display control device 3 is a mobile terminal integrally including the arithmetic processing unit 7 and the display 8, the calculator 32 may obtain a current position of the display 8 from global positioning system (GPS) information or assisted global positioning system (A-GPS) information, for example, and determine the obtained current position to be the display position information.

The calculator 32 calculates the priority on the basis of the obtained distance. For example, as the obtained distance is smaller, the higher the priority calculated by the calculator 32 becomes. The calculator 32 may calculate the priority by multiplying a weight corresponding to the event indicated by the event information by the distance. In this case, the second storage 33 may store therein information about the weights associated with the respective events, and the calculator 32 only needs to read the weight corresponding to the event from the second storage 33. The calculator 32 may calculate the priority by multiplying the obtained distance by a weight in a plane direction in positional relation between the location of the event and the installation position of the display 8 and a weight in the height (floor) direction.

The calculator 32 sends the calculated priority and the event information to the determination unit 34. When the event information is not displayed in the display 36 on the basis of the obtained distance, the calculator 32 only needs to calculate no priority and send no event information to the determination unit 34, for example. When the event information is not displayed in the display 36 on the basis of the obtained distance, the calculator 32 only needs to set a flag or a numerical value that indicates no display of the event information as the priority and send the set item to the determination unit 34.

The second storage 33 is a functional unit that stores therein the information (display position information) about the installation position of the display 8 in the world coordinate system, for example. When the calculator 32 calculates the priority by multiplying a weight corresponding to the event by the distance, the second storage 33 may store therein the information about the weights associated with the respective events. When the display control device 3 is a mobile terminal integrally including the arithmetic processing unit 7 and the display 8, and the calculator 32 obtains the display position information indicating a current position of the display 8 from the GPS information or the A-GPS information, for example, the second storage 33 may store therein the obtained display position information. The second storage 33 may temporarily store therein the event information and the event position information that are received by the second communication unit 31. The second storage 33 is achieved by at least one of the RAM 203 or the auxiliary storage device 205 illustrated in FIG. 3.

The determination unit 34 is a functional unit that determines the display content of the event information on the basis of the priority received from the calculator 32. Specifically, the determination unit 34 determines that the event information is displayed in the display 36 for a time period according to the received priority, for example. When another event information and priority are received in a state where the display 36 displays specific event information, the determination unit 34 may determine that the received event information is displayed in the screen region of the display 36 is a divided manner, or determine that event information having a smaller priority than that of the other event information is not displayed in the display 36. When displaying the event information in a divided manner, the determination unit 34 may determine that a display area of the event information having a higher priority is larger than those of other event information in the display 36. When another event information and priority are received in a state where the display 36 displays specific event information, the determination unit 34 may determine that the screen region of the display 36 is not divided but the event information is sequentially displayed on the basis of a time period according to the priority (e.g., the event information having a high priority is displayed for a longer time period). In this case, the determination unit 34 may determine the order of event information to be displayed on a priority basis or simply on a received order basis. The determination unit 34 sends the event information and the determination result of the display content of the event information to the display controller 35.

The determination unit 34 is not limited to determine the display content of the event information alone. For example, the determination unit 34 may receive, from the calculator 32, the event position information or the information about the distance, and determine the display content of at least one of the pieces of information.

The display controller 35 is a functional unit that controls the display operation of the display 36. Specifically, the display controller 35 causes the display 36 to display the event information in accordance with the display content indicated by the determination result received from the determination unit 34.

The display 36 is a functional unit that displays the event information in accordance with the control of the display controller 35. For example, the display 36 displays the event information with the display content illustrated in FIG. 6. In the example of the display content illustrated in FIG. 6, when the presence of a specific person is detected as the event by the detector 23, the display 8 displays, on a display panel 8a as the event information, the frame (image) from which the event is detected, and further displays a message 81 about the event, a frame 82 indicating the specific person detected as the event, and time information 83 about the time when the event occurs. The display 36 is achieved by the display 8 illustrated in FIG. 3.

The second communication unit 31, the calculator 32, the second storage 33, the determination unit 34, the display controller 35, and the display 36, which are included in the display control device 3 illustrated in FIG. 4, conceptually represent the functions of the display control device 3. The functional structure of the display control device 3 is not limited to such illustrated in FIG. 4. For example, the functional units illustrated in FIG. 4 as independent functional units of the display control device 3 may be structured as a single functional unit. The function of one of the functional units included in the display control device 3 illustrated in FIG. 4 may be divided into a plurality of functions and structured as a plurality of functional units.

The calculator 32, the determination unit 34, and the display controller 35 may be achieved by a hardware circuit such as an ASIC or an FPGA, or by causing the CPU 201 to execute a program stored in the ROM 202 or the auxiliary storage device 205 illustrated in FIG. 3.

FIG. 7 is a flowchart illustrating exemplary display control operation of the display control system in the first embodiment. The following describes a flow of the display control operation performed by the display control system 1 with reference to FIG. 7.

The imaging unit 21 of the monitoring device 2 captures a moving image or still image of the surrounding environment, and causes the first storage 22 of the monitoring device 2 to store therein the data of the captured moving image or still image (step S101). Then, the processing proceeds to step S102.

The detector 23 of the monitoring device 2 detects the occurrence of the event such as a preliminarily assumed person's action, phenomenon, or situation from the frame, which is the moving image or still image stored in the first storage 22 (step S102). If the event is detected (Yes at step S102), the detector 23 acquires the event information associated with the event from the first storage 22, and sends the acquired event information to the first communication unit 25. Then, the processing proceeds to step S103. If no event is detected (No at step S102), the processing returns to step S101.

The estimator 24 of the monitoring device 2 estimates the location of the event on the basis of the frame from which the event is detected by the detector 23. The estimator 24 sends the event position information about the estimated location of the event to the first communication unit 25 of the monitoring device 2 (step S103). Then, the processing proceeds to step S104.

The first communication unit 25 transmits the event information received from the detector 23 and the event position information received from the estimator 24 to the display control device 3 via the network 4 (step S104). Then, the processing proceeds to step S105.

The second communication unit 31 of the display control device 3 receives the event information and the event position information from the monitoring device 2 (the first communication unit 25) via the network 4, and sends the received information to the calculator 32 of the display control device 3. The calculator 32 calculates the priority for displaying the event information in the display 36 on the basis of the event information and the event position information that are received from the second communication unit 31. The calculator 32 sends the calculated priority and the event information to the determination unit 34 (step S105). Then, the processing proceeds to step S106.

The determination unit 34 of the display control device 3 determines the display content of the event information on the basis of the priority received from the calculator 32. The determination unit 34 sends the event information and the determination result of the display content of the event information to the display controller 35 of the display control device 3 (step S106). Then, the processing proceeds to step S107.

The display controller 35 causes the display 36 to display the event information in accordance with the display content indicated by the determination result received from the determination unit 34. The display 36 displays the event information in accordance with the control of the display controller 35 (step S107).

The display control operation is performed by repetition of the processing from step S101 to step S107.

As described above, the display control system 1 according to the first embodiment detects the event from the frame captured by the imaging unit 21, estimates the location of the event, obtains the distance between the location of the event and the display 8, calculates the priority for displaying the event information on the basis of the distance, and controls the display content of the event information on the basis of the calculated priority. The display control system 1, thus, can control the display content of the display control device 3 in accordance with the event detected by the monitoring device 2 and the distance between the location of the event and the display 8. Although a plurality of events are detected by the monitoring device 2, the display control system 1 can preferentially display the event information having a high priority calculated for the event.

### Second Embodiment

The following describes a display control system 1a according to a second embodiment primarily on the basis of the differences from the display control system 1 according to the first embodiment. In the first embodiment, the display control operation of the event information is described that is performed by the display control system 1 including the monitoring device 2 and the display control device 3. In the second embodiment, the display control operation of the event information is described that is performed by the display control system 1a including a plurality of monitoring devices 2 and display control devices 3. The hardware structure and the functional block structure of each of the monitoring devices 2 and display control devices 3 according to the second embodiment are the same as those described in the first embodiment.

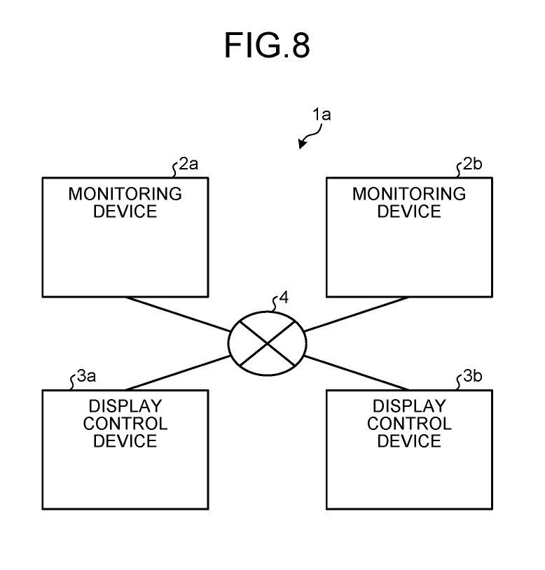

FIG. 8 is a schematic diagram illustrating an exemplary structure of the display control system in the second embodiment. The following describes the structure of the display control system 1a with reference to FIG. 8.

As illustrated in FIG. 8, the display control system 1a according to the second embodiment includes monitoring devices 2a and 2b, and display control devices 3a and 3b. The monitoring devices 2a and 2b, and the display control devices 3a and 3b are communicably coupled to one another via the network 4. When one of the monitoring devices 2a and 2b is described or the monitoring devices 2a and 2b are collectively described, the “monitoring device 2” is simply used for the description in some cases. When one of the display control devices 3a and 3b is described or the display control device 3a and 3b are collectively described, the “display control device 3” is simply used for the description in some cases.

The monitoring devices 2a and 2b each detect the event from the frame of captured moving image or still image and transmit (broadcast) the event information and the event position information about the detected event to all of the display control devices 3 (in FIG. 8, the display control devices 3a and 3b) via the network 4.

The display control devices 3a and 3b each determine the display content of the event information transmitted by the monitoring device 2 in a broadcast manner and whether the event information is displayed on the basis of the calculated priority.

In the example illustrated in FIG. 8, two each of the monitoring devices 2 and the display control devices 3 are included. Each of the numbers of monitoring devices 2 and display control devices 3 is not limited to two. The number of at least one of monitoring devices 2 or display control devices 3 may be three or more. The display control system 1a illustrated in FIG. 8 includes a plurality of monitoring devices 2 (two devices in FIG. 8) and a plurality of display control devices 3 (two controllers in FIG. 8). The numbers of monitoring devices 2 and display control devices 3 are not limited to those in FIG. 8. The display control system 1a may include the single monitoring device 2 and the plurality of display control devices 3. The display control system 1a may include the plurality of monitoring device 2 and the single display control device 3.

The functions of the monitoring devices 2a and 2b, the display control devices 3a and 3b, and the network 4 illustrated in FIG. 8 are the same as those described with reference to FIG. 1.

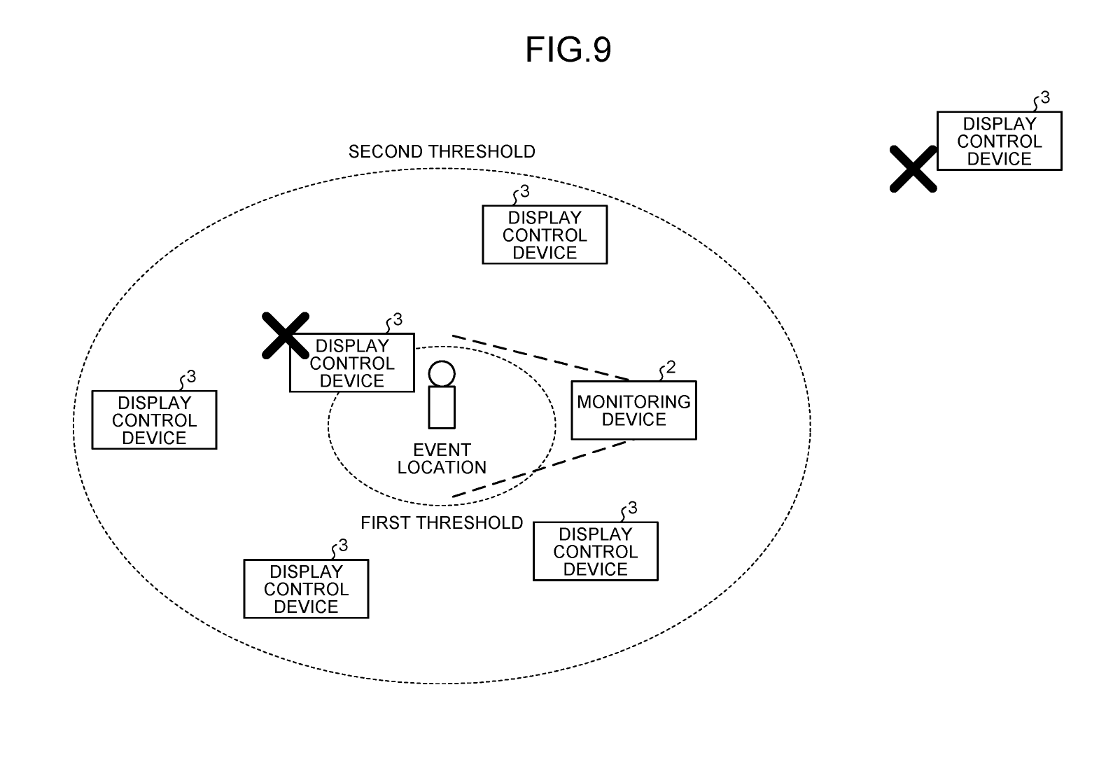

FIG. 9 is a schematic diagram explaining an example of the display control devices that display the event information. The following describes the operation of the functional blocks of the display control system 1a primarily on the basis of the differences from the first embodiment with reference to FIG. 9.

The calculator 32 of the display control device 3 calculates the priority for displaying the event information in the display 36 on the basis of the event information and the event position information that are received from the second communication unit 31. Specifically, the calculator 32 obtains the distance between the location of the event and the position where the display 8 is present on the basis of the location of the event, which is indicated by the event position information received from the second communication unit 31, and the position (the position where the display 8 is present) indicated by the display position information stored in the second storage 33. The calculator 32 determines whether the obtained distance is equal to or larger than a first threshold and equal to or smaller than a second threshold (which is larger than the first threshold), as illustrated in FIG. 9. The calculator 32 calculates the priority on the basis of the determination result. When the obtained distance is equal to or larger than the first threshold and equal to or smaller than the second threshold, the calculator 32 obtains, as the priority, a value or a flag indicating that the event information is displayed in the display 36, for example.

The determination unit 34 determines the display content of the event information on the basis of the priority received from the calculator 32. For example, when the received priority is the value or the flag indicating that the event information is displayed in the display 36, the determination unit 34 determines that at least the event information is displayed in the display 36.

The display controller 35 causes the display 36 to display the event information in accordance with the display content indicated by the determination result received from the determination unit 34. The display 36 displays the event information in accordance with the control of the display controller 35.

As described above, the monitoring device 2 detects the event from the frame of captured moving image or still image and transmits (broadcasts) the event information and the event position information about the detected event to all of the display control devices 3 via the network 4. The display control device 3 determines whether the distance between the location of the event and the position where the display 8 of the display control device 3 is installed is equal to or larger than the first threshold and equal to or smaller than the second threshold, and when the distance is equal to or larger than the first threshold and equal to or smaller than the second threshold, causes the display 8 to display the event information. The display control system 1a, thus can cause only the display control devices 3 present in a specific region that is determined on the basis of the event location as a reference to display the event information. For example, when the display control system 1a is a security system that makes notification of a specific person and the event of a specific person who appears to be dangerous being detected occurs, the display control system 1a can cause the display control device 3 present near the location of the event, i.e., the position where the specific person is present, not to display the event information. This can prevent a situation from occurring that the specific person recognizes that the person himself/herself is displayed in the display control device 3 as the event information. The display control system 1a can cause the display control device 3 not to display the event information when the display control device 3 is installed far away from the location of the event and to which the notification of the presence of the specific person is not required.

When the monitoring devices 2 included in the display control system 1a have the same visual field, the display control system 1a can increase accuracy of estimating the location of the event. When the monitoring devices 2 included in the display control system 1a each have an independent visual field, the display control system 1a can monitor wider range of the surrounding environment.

The calculator 32 determines whether the obtained distance is equal to or larger than the first threshold and equal to or smaller than the second threshold. The determination manner is, however, an example. In another example, the calculator 32 may determine whether the distance is equal to or larger than a certain threshold. The calculation manner of the priority performed by the calculator 32 is not limited to that the manner described above. For example, the calculation manner described in the first embodiment may be employed.

### Third Embodiment

The following describes a display control system 1b according to a third embodiment primarily on the basis of the differences from the display control system 1a according to the second embodiment. In the second embodiment, the monitoring device 2 broadcasts the event information and the event position information via the network. In the third embodiment, with management device interposed between the monitoring device 2 and the display control device 3, the event information is transmitted from the management device to only the display control device 3 that satisfies a condition. The structure and operation are described below. The hardware structure and the functional block structure of each of the monitoring device 2 and the display control device 3 according to the embodiment are the same as those described in the first embodiment.

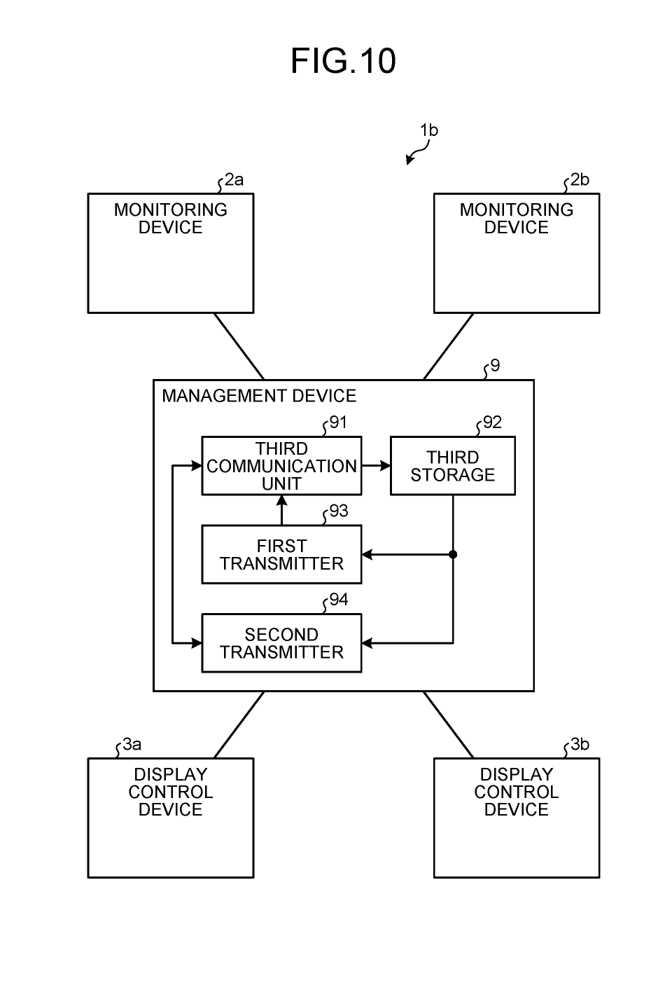

FIG. 10 is a schematic diagram illustrating an exemplary functional block structure of the display control system in the third embodiment. The following describes the structure of the display control system 1b, and a functional block structure and operation of a management device 9 with reference to FIG. 10.

As illustrated in FIG. 10, the display control system 1b according to the third embodiment includes the monitoring devices 2a and 2b, the display control devices 3a and 3b, and the management device 9. As illustrated in FIG. 10, the management device 9 is interposed between the monitoring devices 2a and 2b, and the display control devices 3a and 3b. Although FIG. 10 illustrates the monitoring device 2 and the display control device 3 in such a manner that they are directly connected to the management device 9, a network may be provided among the monitoring device 2, the display control device 3, and the management device 9.

The monitoring devices 2a and 2b each detect the event from the frame of captured moving image or still image and transmit, to the management device 9, the event information and the event position information about the detected event.

The management device 9 is a server that receives the event information and the event position information from all of the monitoring devices 2, and transmits the event information to only the display control device 3 that satisfies a certain condition. The management device 9 has the same hardware structure as the arithmetic processing unit 7 illustrated in FIG. 3. The management device 9 causes the auxiliary storage device 205 illustrated in FIG. 3 to store therein the event information and the event position information that are received from the monitoring devices 2. This allows the event information and the event position information that are received from the monitoring devices 2 to be managed in a unitary manner.

The display control devices 3a and 3b each receive the event position information about the event detected by the monitoring device 2, and when the distance between the location of the event and the position where the display 8 is present satisfies a certain condition, transmit an event information request to the management device 9 and receive the event information from the management device 9.

As illustrated in FIG. 10, the management device 9 includes a third communication unit 91 (management receiving unit), a third storage 92, a first transmitter 93 (first management transmitter), and a second transmitter 94 (second management transmitter).

The third communication unit 91 is a functional unit that receives the event information and the event position information from the monitoring device 2, and transmits the event information to the display control device 3 that satisfies a certain condition. The third communication unit 91 is achieved by the communication I/F 206 illustrated in FIG. 3.

The third storage 92 is a functional unit that stores therein the event information and the event position information that are received by the third communication unit 91. The third storage 92 is achieved by the auxiliary storage device 205 illustrated in FIG. 3.

The first transmitter 93 is a functional unit that transmits the event position information stored in the third storage 92 and an address (e.g., an IP address) of the management device 9 to all of the display control devices 3 via the third communication unit 91.

The second transmitter 94 is a functional unit that transmits the event information indicated by the event information request to the display control device 3 via the third communication unit 91 when receiving the event information request from the display control device 3.

The third communication unit 91, the third storage 92, the first transmitter 93, and the second transmitter 94, which are included in the management device 9 illustrated in FIG. 10, conceptually represent the functions of the management device 9. The functional structure of the management device 9 is not limited to that illustrated in FIG. 10. For example, the functional units illustrated in FIG. 10 as independent functional units of the management device 9 may be structured as a single functional unit. The function of one of the functional units included in the management device 9 illustrated in FIG. 10 may be divided into a plurality of functions and structured as a plurality of functional units.

Each of the first transmitter 93 and the second transmitter 94 may be achieved by a hardware circuit such as an ASIC or an FPGA, or by causing the CPU 201 to execute a program stored in the ROM 202 or the auxiliary storage device 205 illustrated in FIG. 3.

The calculator 32 of the display control device 3 receives the event position information and the address of the management device 9, which are received by the second communication unit 31 from the management device 9. The calculator 32 obtains the distance between the location of the event and the position where the display 8 is present on the basis of the location of the event, which is indicated by the event position information received from the second communication unit 31, and the position (the position where the display 8 is present) indicated by the display position information stored in the second storage 33. The calculator 32 determines whether the obtained distance satisfies a certain condition (e.g., the distance is equal to or larger than the first threshold and equal to or smaller than the second threshold, as illustrated in FIG. 9). When the obtained distance satisfies the certain condition, the calculator 32 transmits the event information request to request the received event information to the management device 9 identified by the received address via the second communication unit 31. When the obtained distance does not satisfy the certain condition, the calculator 32 does nothing.

The calculator 32 receives the event information from the management device 9 in response to the event information request via the second communication unit 31, and calculates, as the priority, a value or a flag, for example, indicating that the event information is displayed in the display 36.

The determination unit 34 determines the display content of the event information on the basis of the priority received from the calculator 32. For example, when the received priority is the value or the flag indicating that the event information is displayed in the display 36, the determination unit 34 determines that at least the event information is displayed in the display 36.

The display controller 35 causes the display 36 to display the event information in accordance with the display content indicated by the determination result received from the determination unit 34. The display 36 displays the event information in accordance with the control of the display controller 35.

As described above, with the management device 9 interposed between the monitoring device 2 and the display control device 3, the management device 9 controls the event information received from the monitoring device 2 in a unity manner. The management device 9 transmits the event information to only the display control device 3 that satisfies a certain condition in relation to the distance between the location of the event and the position where the display 8 is present. This eliminates the necessity to transmit the event information to all of the display control devices 3, thereby making it possible to reduce traffic in the network. As a result, a load in the information processing in the display control device 3 can be reduced.

### Fourth Embodiment

The following describes a display control system 1c according to a fourth embodiment primarily on the basis of the differences from the display control system 1 according to the first embodiment. In the first embodiment, the distance between the location of the event and the position where the display 8 is present is obtained on the basis of the event position information, and the priority for displaying the event information is obtained on the basis of the distance. In the fourth embodiment, with a user interface (UI) added to the display control device 3, a user can adjust the priority for the event information. The structure having such function and its operation are described below. The hardware structures of a monitoring device 2c and a display control device 3c according to the embodiment are the same as those described in the first embodiment.

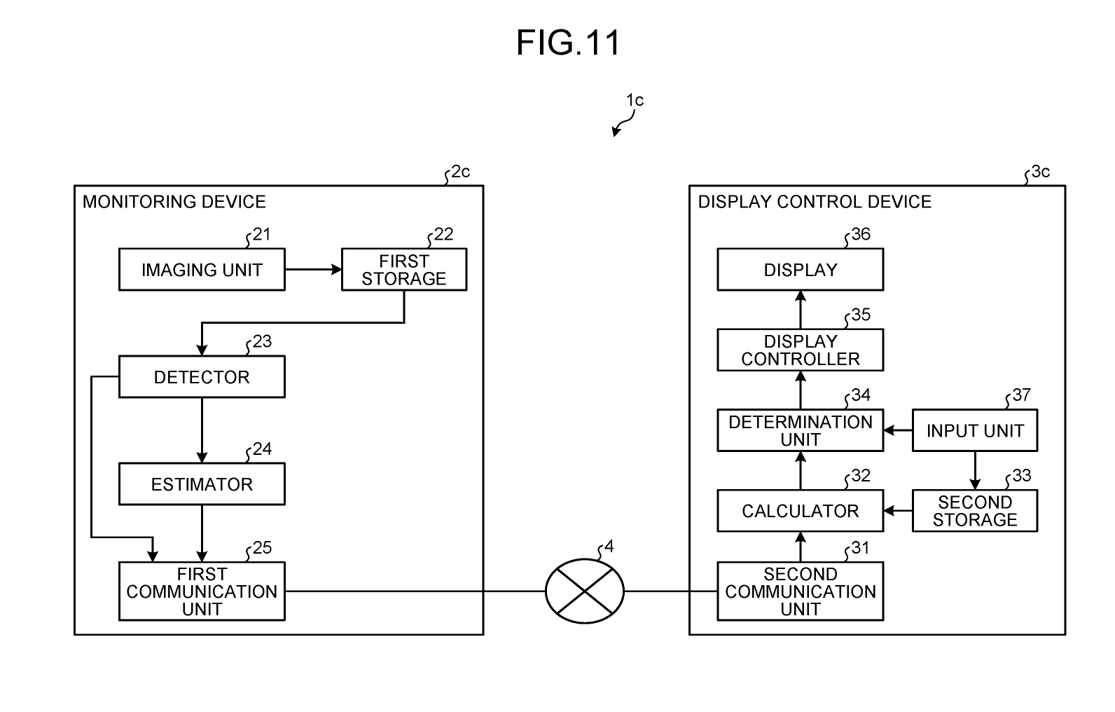

FIG. 11 is a schematic diagram illustrating an exemplary functional block structure of the display control system in the fourth embodiment. The following describes the functional block structure and operation of the display control system 1c with reference to FIG. 11. The functional block structure of the monitoring device 2c according to the embodiment is the same as that of the monitoring device 2 according to the first embodiment.

As illustrated in FIG. 11, the display control device 3c of the display control system 1c includes the second communication unit 31, the calculator 32, the second storage 33, the determination unit 34, the display controller 35, the display 36, and an input unit 37 (first user interface unit). The basic operation of each of the second communication unit 31, the calculator 32, the second storage 33, the determination unit 34, the display controller 35, and the display 36 is the same as that described in the first embodiment.

The calculator 32 of the display control device 3c receives the event information and the event position information from the monitoring device 2c via the second communication unit 31. The calculator 32 obtains the distance between the location of the event and the position where the display 8 is present on the basis of the location of the event, which is indicated by the event position information received from the second communication unit 31, and the position (the position where the display 8 is present) indicated by the display position information stored in the second storage 33. The calculator 32 determines whether the obtained distance satisfies a certain condition (e.g., the distance is equal to or larger than the first threshold and equal to or smaller than the second threshold, as illustrated in FIG. 9), and calculates, as the priority, a value or a flag, for example, indicating the display of the event information.

The determination unit 34 determines the display content of the event information on the basis of the priority received from the calculator 32. For example, when the received priority is the value or the flag indicating that the event information is displayed in the display 36, the determination unit 34 determines that at least the event information is displayed in the display 36.

The input unit 37 is a functional unit that functions as a user interface via which a user who uses the display control device 3c operates and adjusts the priority such as a value or a flag indicating the display of the event information. The input unit 37 is achieved by the operation device 208 illustrated in FIG. 3.

The input unit 37 is used for adjusting the first and the second thresholds used by the calculator 32 when determining whether the event information is displayed on the basis of the distance between the location of the event and the position where the display 8 is present. The adjusted priority and the thresholds are stored in the second storage 33. The calculator 32 calculates the priority using the adjusted thresholds, and the determination unit 34 determines whether the event information is displayed on the basis of the calculated priority. For example, a list of predetermined event names is displayed and an on-off designation that represents whether the event information is displayed is designated for each piece of event information. When the event information is designated as the off designation, the event information is not displayed. Alternatively, the calculator 32 displays the priority of the event information stored therein as a continuous value so as to enable the priority of the event information to be adjustable for each piece of event information. Examples of the adjustment manner may include a manner that directly designates a number, and a manner that adjusts the priority with a slide bar. Likewise, examples of the adjustment manner of the distance may include a manner that directly designates a number, and a manner that adjusts the distance with a slide bar. For another example, the display of the event information may be designated floor by floor in a building in such a manner that a floor is not notified of the event in another floor.

The display control device 3c may be a mobile device, the position of which is not fixed but is changeable, such as a smartphone. The display control system 1c according to the fourth embodiment is workable when limited users receive the display of the event information and the display control device 3c is a device that is personally managed such as a smartphone.

When a single user receives the displayed event information, the display 36 may inform the user of the event information with a vibration pattern preliminarily associated with the event information, with a sound pattern preliminarily associated with the event information, or with one of the combinations of vibration, sound, and image, instead of the presentation of the image information and the video information.

The fourth embodiment thus structured can adjust the priority and various thresholds via the user interface (the input unit 37), thereby making it possible to perform more appropriate display control of the event information.

The structure of the display control device 3c, which includes the input unit 37 serving as the user interface as in the fourth embodiment, is applicable to the display control system 1b according to the second embodiment and the display control system 1c according to the third embodiment.

### Fifth Embodiment

The following describes a display control system 1d according to a fifth embodiment primarily on the basis of the differences from the display control system 1 according to the first embodiment. In the first embodiment, the monitoring device 2 acquires the event information and the event position information by analyzing the image and video information captured by the imaging unit 21, and transmits the acquired information to the display control device 3 via the network. In the fifth embodiment, with a user interface added to the monitoring device therein, a user can register the event information including a starting time of the event and the position information (event position information) about the event. The structure having such function and its operation are described below. The hardware structures of a monitoring device 2d and a display control device 3d according to the embodiment are the same as those described in the first embodiment.

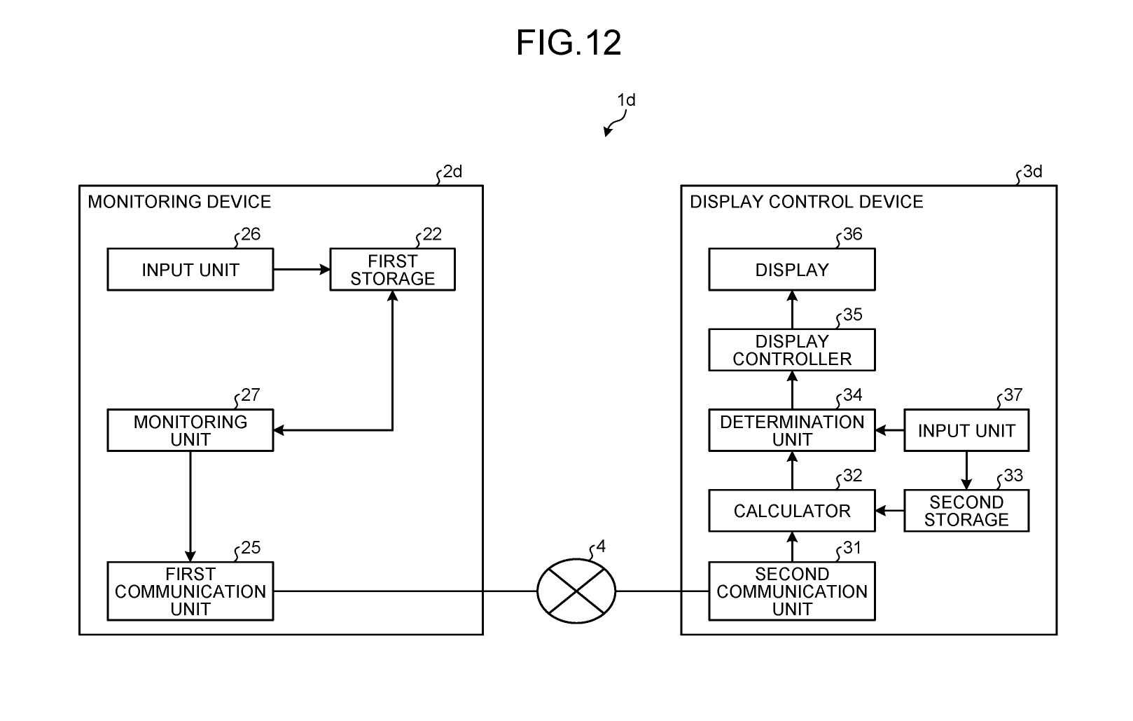

FIG. 12 is a schematic diagram illustrating an exemplary functional block structure of the display control system in the fifth embodiment. The following describes the functional block structure and operation of the display control system 1d with reference to FIG. 12. The functional block structure of the display control device 3d according to the embodiment is the same as that of the display control device 3c according to the fourth embodiment.

As illustrated in FIG. 12, the monitoring device 2d of the display control system 1d includes the first storage 22, the first communication unit 25, an input unit 26 (second user interface unit), and a monitoring unit 27.

The monitoring device 2d allows a user to input event information preliminarily known using the input unit 26. For example, the user, using the input unit 26, registers an event of a bargain, the event information including a starting time of 16:00, and the event position information of an exhibition site A to cause the first storage 22 of the monitoring device 2d to store therein the information that the bargain will be conducted at the exhibition site A at 16:00 tomorrow. The input unit 26 is achieved by the operation device 109 illustrated in FIG. 2.

The monitoring unit 27 is a functional unit that monitors whether a current time reaches the starting time included in the event information registered via the input unit 26. When the current time reaches the starting time, the monitoring unit 27 transmits the event information and the event position information to the display control device 3d via the first communication unit 25.

The embodiment thus structured allows the user to register the event information and the event position information via the user interface, thereby making it possible to increase the convenience.

The structure of the monitoring device 2d, which includes the input unit 26 serving as the user interface in the fifth embodiment, is applicable to the display control system 1b according to the second embodiment and the display control system 1c according to the third embodiment.

### Sixth Embodiment

The following describes a display control system 1e according to a sixth embodiment primarily on the basis of the differences from the display control system 1c according to the fourth embodiment. In the fourth embodiment, the event information and the event position information are obtained from the image captured by the imaging unit 21. In the sixth embodiment, the event information and the event position information can be detected by a detector 23a included in a monitoring device 2e. The structure having such function and its operation are described below. The hardware structures of the monitoring device 2e and a display control device 3e according to the embodiment are the same as those described in the first embodiment.

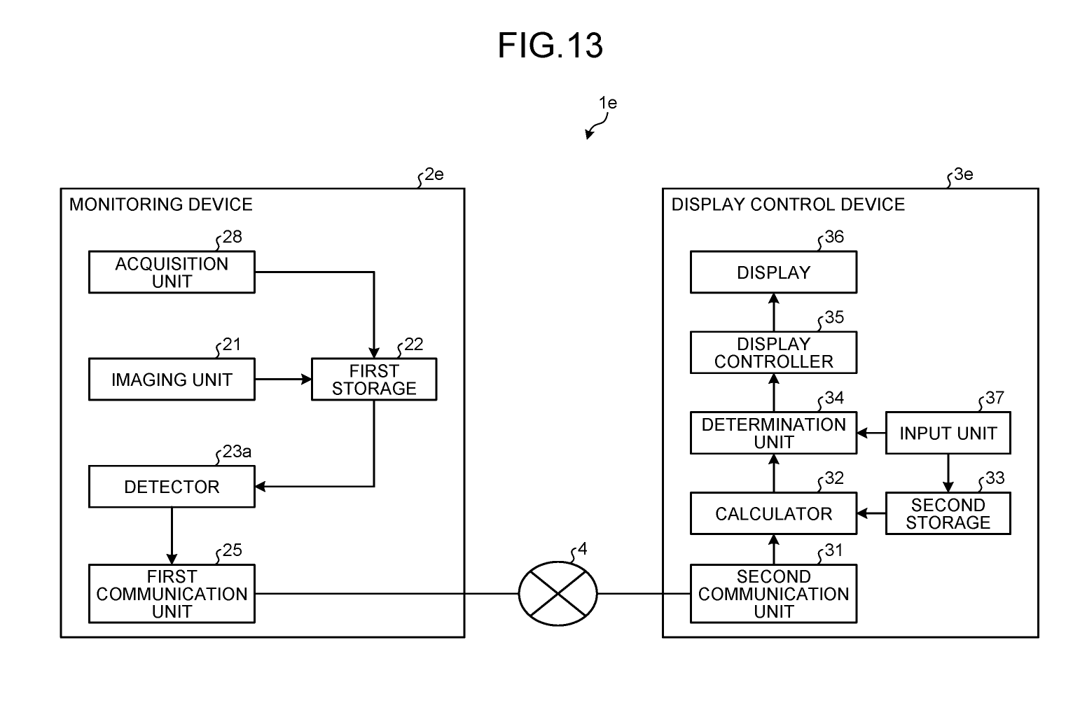

FIG. 13 is a schematic diagram illustrating an exemplary functional block structure of the display control system in the sixth embodiment. The following describes the functional block structure and operation of the display control system 1e with reference to FIG. 13. The functional block structure of the display control device 3e according to the embodiment is the same as that of the display control device 3c according to the fourth embodiment.

As illustrated in FIG. 13, the monitoring device 2e of the display control system 1e includes the imaging unit 21, the first storage 22, the detector 23a, the first communication unit 25, and an acquisition unit 28.

The acquisition unit 28 is a functional unit that acquires sensing information.

The detector 23a is a functional unit that detects the event from the sensing information acquired by the acquisition unit 28. For example, the detector 23a estimates the number of persons who have stepped off an elevator at a desired floor based on a loaded weight of the elevator and open-close information of the elevator, and causes the display control device 3e to perform a display in accordance with the number of persons. Accordingly, the total number of persons on each floor can be estimated, and information about another floor is displayed on the display (the display control device 3e) on the floor where congestion reaches a certain level or more, thereby making it possible to level the total number of crowds among floors. Displaying the state of congestion on a certain floor on the displays (the display control devices 3e) of other floors informs people that the floor is now popular, thereby making it possible to draw more people to the floor. The detector 23a performs determination on the sensing information acquired from the acquisition unit 28, and transmits the event information according to the determination result to the display control device 3e via the first communication unit 25. The sensing information is time series information represented by a scalar value obtained from a sensor, for example. The detector 23a performs noise elimination such as adaptive median filtering on the time series information, and determines that the event occurs when a resulting value exceeds a threshold after predetermined threshold processing is performed. Each sensor and the event information correspond one-on-one. An event is present that is defined by co-occurrence of events. For example, the detector 23a detects an event produced by the co-occurrence of the open-close event of the elevator and the load change event in the elevator. Furthermore, the detector 23a may analyze a video acquired from the imaging unit 21, detect the event information and the event position information, and detect another event on the basis of the co-occurrence of the information acquired from the sensing information.

The sixth embodiment detects the event on the basis of not only the image captured by the imaging unit 21 but also the sensing information, thereby making it possible for the display control system to increase the convenience.

The structure of the monitoring device 2e according to the sixth embodiment is applicable to the display control system 1b according to the second embodiment and the display control system 1c according to the third embodiment.

The programs executed by the monitoring device 2, the display control device 3, and the management device 9 in the respective embodiments may be provided by being preliminarily stored in a ROM, for example.

The programs executed by the monitoring device 2, the display control device 3, and the management device 9 in the respective embodiments may be recorded and provided as computer program products in a computer-readable recording medium such as a compact disc read only memory (CD-ROM), a flexible disk (FD), a compact disc recordable (CD-R), and a digital versatile disc (DVD), as installable or executable files.

The programs executed by the monitoring devices 2, and 2a to 2e, the display control devices 3, and 3a to 3e, and the management device 9 in the embodiments may be stored in a computer connected to a network such as the Internet, and be provided by being downloaded via the network. The programs executed by the monitoring devices 2, and 2a to 2e, the display control devices 3, and 3a to 3e, and the management device 9 in the embodiments may be provided and distributed via a network such as the Internet.

The programs executed by the monitoring devices 2, and 2a to 2e, the display control device 3, and 3a to 3e, and the management device 9 in the embodiments may cause a computer to function as the respective functional units of the nodes. The CPU of the computer can read out the programs from the computer readable storage medium to the main storage device and execute the programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display control device comprising:
hardware processing circuitry programmed to:
acquire event information indicating an event and event position information indicating a location of the event, the event detected from an image captured by an imager;
calculate a priority for displaying the event information based on at least one of the event position information or the event information;
determine a display format of the event information based at least in part on the priority; and
cause a display to display the event information in accordance with the display format determined.

2. The device according to claim 1, wherein the hardware processing circuitry calculates the priority based at least in part on a distance between the location of the event indicated by the event position information and a location of the display.

3. The device according to claim 2, further comprising a storage to store display position information indicating the location of the display, wherein
the hardware processing circuitry reads the display position information from the storage and obtains the distance between the location of the display indicated by the display position information and the location of the event indicated by the event position information.

4. The device according to claim 1, further comprising a first user interface comprising one or more hardware processors programmed to adjust the priority.

5. The device according to claim 2, wherein the hardware processing circuitry is further programmed to:
determine whether the distance is at one of a first threshold or a second threshold or between the first threshold and the second threshold, the second threshold larger than the first threshold; and
calculate the priority indicating that the event information is displayed in the display when determining that the distance is at one of the first threshold or the second threshold or between the first threshold or the second threshold.

6. The device according to claim 1, wherein, when the hardware processing circuitry acquires a plurality of pieces of event information, the hardware processing circuitry determines the display format to comprise displaying the pieces of event information in an image region of the display in a divided manner in accordance with the priority corresponding to each of the pieces of event information.

7. The device according to claim 1, wherein, when the hardware processing circuitry acquires a plurality of pieces of event information, the hardware processing circuitry determines the display format to comprise displaying the pieces of event information in an image region of the display in a sequential manner in accordance with the priority corresponding to each of the pieces of event information.

8. The device according to claim 1, wherein
the event is detected from an image captured by an imager, and
the event position information is obtained by the imaging device.

9. A display control system comprising:
one or more display control devices each according to claim 1; and
one or more imaging devices.

10. The system according to claim 9, wherein each imaging device programmed to detect an event from an image captured by each of the one or more imaging devices, and obtain event position information indicating a location of the event.

11. The system according to claim 9, wherein the imaging device comprises:
an imager that captures the image; and
processing circuitry programmed to;
detect the event from the captured image;
estimate the location of the event from the captured image; and
transmit the event information indicating the event and the event position information indicating the location of the event.

12. A display control system comprising:
one or more display control devices each according to claim 1; and
a monitoring device comprising:
a second user interface to register the event information comprising a starting time of the event and the event position information, and
a monitoring unit configured to monitor whether a current time reaches the starting time.

13. A display control system comprising:
one or more display control devices according to claim 1; and
a monitoring device comprising:
an acquisition unit configured to acquire sensing information, and
a detector configured to detect the event from the sensing information.

14. The system according to claim 9, further comprising a management unit configured to receive the event information and the event position information from the imaging device and transmit the event information to the display control device that satisfies a certain condition of the distance between the location of the event and the location of the display.

15. The display control system according to claim 13, wherein
the management device comprises
a management receiver configured to receive the event information and the event position information from the imaging device; and
a first management transmitter configured to transmit the event position information and an address of the management device to the display control device,
the receiver of the display control device receiving the event position information and the address that are transmitted by the first management transmitter,
the calculator of the display control device determining whether the calculated distance satisfies a certain condition and transmits, to the management device, an event information request that requests the event information when the calculated distance satisfies the certain condition, and
the management device further comprising:
a second management transmitter configured to transmit the event information requested by the event information request to the display control device that has transmitted the event information request when the management receiver receives the event information request.

16. A display control method comprising:
Acquiring event information indicating an event and event position information indicating a location of the event, the event detected from an image captured by an imager;
calculating a priority for displaying the event information based on at least one of the event position information or the event information;
determining a display format of the event information based at least in part on the priority; and
causing a display to display the event information in accordance with the display format determined.
